(19) United States
(12) Patent Application Publication
(10) Pub. No.: US 2020/0226583 A1
(43) Pub. Date: Jul. 16, 2020

(54) Machine-Readable Code Processing

(71) Applicant: Google LLC, Mountain View, CA (US)

(72) Inventor: Phalachandra Sreepada Bhat, Palo Alto, CA (US)

(21) Appl. No.: 16/635,824

(22) PCT Filed: Jun. 7, 2018
(86) PCT No.: PCT/US2018/036533

§ 371 Date: Jan. 31, 2020

Related U.S. Application Data
(60) Provisional application No. 62/539,806, filed on Aug. 1, 2017.

(51) Int. Cl. G06Q 20/32; G06Q 20/08; G06Q 20/40

(52) U.S. Cl. CPC G06Q 20/3276; G06Q 20/4016; G06Q 20/0855

(57) ABSTRACT

The examples enable a process to be initiated with a machine-readable code, such as a QR code. A user computing device receives an input to initiate the camera module at a time of an interaction with a third party. The user device receives a digital image from the camera module, the digital image comprising a machine-readable code. The user device extracts data from the machine-readable code, such as an identification of the third party, a third party account, and a specific record to be transferred. The user device communicates to a processing system, the extracted data, data associated with a user device, and a request to communicate the record to the third party. In certain examples the method enables the processing to be completed with no other input required of the user than scanning of the machine-readable code.

### CROSS-REFERENCE TO RELATED APPLICATION

This patent application claims priority to U.S. Provisional Patent Application No. 62/539,806, filed Aug. 1, 2017, and entitled “Machine-Readable Code Processing.” The entire contents of the above-identified application are hereby fully incorporated herein by reference.

### TECHNICAL FIELD

The examples described herein enable a process to be initiated with a machine-readable code, such as a QR code. The examples optionally enable the processing to be completed with no other input required of the user than a scanning of the QR code.

### BACKGROUND

Machine-readable codes are used for a very large and rapidly growing number of payment transactions, both in the United States and in foreign markets. However, the methods to initiate a machine-readable code process can be cumbersome. For example, processing a machine-readable code often requires opening a third party application on the user computing device, selecting four or more options in the user interface, scanning the machine-readable code, and then entering an process details in order to complete the processing.

### Overview

Machine-readable codes include QR codes, barcodes, alphanumeric codes, or any other suitable code. Machine-readable codes of any type are represented throughout the specification as QR codes.

In a desired user experience, a user simply opens a camera module on the user computing device and directs the camera at a presented QR code to initiate a process, such as a purchase transaction. The QR code is automatically read and a payment flow is initiated. A separate application for scanning QR codes is not required because the camera module is configured to interpret the QR code data. For example, the user would then enter an amount for the transaction and select an option on the user interface to confirm the transaction in an opened payment application or other application. In another example, the user simply scans the QR code to complete the transaction. The entering of an amount and a confirmation is not required. The transaction may be conducted in a separate payment application or directly from the camera module.

In certain examples, functionality for automatically initiating a transaction based on a scan of a QR code is built directly into the camera module. That is, when the camera module application recognizes a QR code, a payment process is initiated. For example, the camera module automatically opens a payment application, and the QR code data is imported into the payment application to conduct a transaction. In another example, the payment processing actions are incorporated into the camera module to allow transactions to be conducted from the camera module. Any other suitable software or hardware solution that allows transactions to be conducted when the camera module recognizes a QR code may be employed. The scanning of the QR code and the interpretation of payment QR Code to initiate the appropriate payment method may be written into the camera application programming interface (“API”).

The data required for the transaction to be conducted, such as a transaction amount, may be encoded into the QR code. That is, when the QR code is scanned, all required payee data for conducting the transaction is encoded in the QR, and thus received by the user computing device. This scanning is conducted directly by the camera module, and a separate QR code scanning application is not required. For example, the transaction amount, the merchant identification, information about the product or service purchased, or any other useful data are all included in the data encoded in the QR code. When the QR code is scanned, required data is received and interpreted by the user computing device. This example is especially useful for cases where the transaction amount and merchant system are standardized, such as highway tolls.

The system allows a user to conduct the transaction in certain situations without the requirement of a confirmation or verification step. That is, after the QR code is scanned, the transaction is conducted automatically without the user verifying the transaction. The act of scanning the QR code is the only action required of the user.

In an example, the system will optionally authorize the user to conduct automatic transactions based on risk signals. For example, if the transaction is for a small amount at a frequent merchant, the risk can be determined to be low enough that verification is not required. For example, if a user pays a fee to ride a subway everyday, a subsequent QR code transaction at the subway will be determined to be a low risk and does not require verification from the user. In another example, the system is configured to allow any transaction under a certain amount to be conducted without verification from the user.

In an example, the storage device and the camera module are components of a user computing device and the system further comprises one or more computing devices of a merchant system associated with the third party. For example, the one or more computing devices of the merchant system are configured to configure a payment account to receive payments from users, receive a request to conduct a transaction, create a machine-readable code comprising data associated with an account of the merchant system; present the machine-readable code to a particular user associated with the user computing device, and receive a notice that the user has provided a transfer of funds to the account.

A computer program product comprises portions of program code, which, when executed by one or more processors of a computing device, cause the computing device to perform any of the methods described herein.

In examples, the transfer of funds in the transaction is a transfer of any other suitable digital records. For example, the third party is an entity that is controlling access to a facility. Upon scanning the machine-readable code, the camera module 114 communicates the related data to a processing system that verifies identifications and communicates records to the third party. In this example, the communicated record is an authorization to permit access to the user 101. In this and other examples, the transaction is merely an interaction between the user 101 and the third party. In other examples, the transaction is not a financial transaction, but merely a digital record exchange.

By using and relying on the methods and systems described herein, the user experiences faster payment flow resulting in better experience for a user and a higher usage rate for the associated payment methods. The user may conduct a transaction by simply opening a camera module and pointing it at a QR code. All the other steps typically required of a user to actuate a payment application, enter the transaction details, and verify the transaction are not required. Further, the system includes an ability to support all third party payment applications and is not specific to just one party.

### BRIEF DESCRIPTION OF THE DRAWINGS

FIG. 1 is a block diagram depicting a system to initiate a payment transaction with a machine-readable code, in accordance with certain examples.

FIG. 2 is a block flow diagram depicting a method to enable a process to be initiated with a machine-readable code, in accordance with certain examples.

FIG. 3 is an illustration of an example user computing device scanning a machine-readable code, in accordance with certain examples.

FIG. 4 is a block diagram depicting a computing machine and module, in accordance with certain examples.

### EXAMPLE SYSTEM ARCHITECTURE

Turning now to the drawings, in which like numerals indicate like (but not necessarily identical) elements throughout the figures, examples are described in detail.

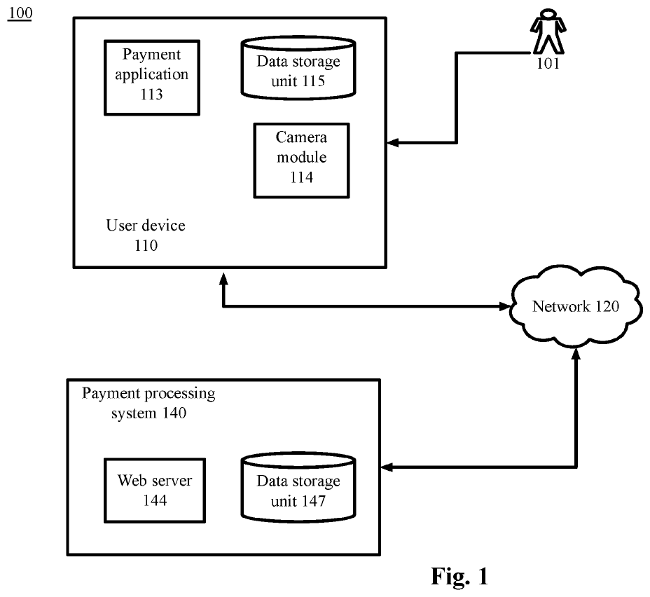

FIG. 1 is a block diagram depicting a system 100 to initiate a payment transaction with a machine-readable code, in accordance with certain examples. As depicted in FIG. 1, the system 100 comprises network computing devices 110 and 140 that are configured to communicate with one another via one or more networks 120. In some embodiments, a user associated with a device must install an application and/or make a feature selection to obtain the benefits of the techniques described herein.

In examples, the network 120 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy (“BLE”), near field communication (“NFC”), ultrasound communication, or any combination thereof or any other appropriate architecture or system that facilitates the communication of signals, data, and/or messages. Throughout the discussion of examples, it should be understood that the terms “data” and “information” are used interchangeably herein to refer to text, images, audio, video, or any other form of information that can exist in a computer-based environment.

Each network computing device 110 and 140 includes a device having a communication module capable of transmitting and receiving data over the network 120. For example, each network computing device 110 and 140 can include a server, desktop computer, laptop computer, tablet computer, a television with one or more processors embedded therein and/or coupled thereto, smart phone, handheld computer, personal digital assistant (“PDA”), video game device, wearable computing device, or any other wired or wireless, processor-driven device. In the example depicted in FIG. 1, the network computing devices 110 and 140 are operated by users 101 and payment processing system 140 operators, respectively.

An example user computing device 110 comprises a payment application 113, a data storage unit 115, and a camera module 114.

In an example, the payment application 113 is a program, function, routine, applet, or similar entity that exists on and performs its operations on the user computing device 110. In certain examples, the user 101 must install the payment application 113 and/or make a feature selection on the user computing device 110 to obtain the benefits of the techniques described herein. In an example, the user 101 may access payment application 113 on the user computing device 110 via a user interface. In an example, the payment application 113 may be associated with the payment processing system 140. In another example, the payment application 113 may be associated with a merchant system (not shown).

In an example, the camera module 114 may be any module or function of the user computing device 110 that captures a digital image. The camera module 114 may be resident on the user computing device 110 or in any manner logically connected to the user computing device 110. For example, the camera module 114 may be connected to the user computing device 110 via the network 120. The camera module 114 may be capable of obtaining individual images or a video scan. Any other suitable image capturing device may be represented by the camera module 114.

In an example, the camera module 117 includes the capability to initiate a transaction by opening the payment application 113 and communicating data to the payment application 113, or communicating directly with the payment processing system 140 upon reading a machine-readable code instructing the camera module to initiate a payment process.

In an example, the data storage unit 115 comprises a local or remote data storage structure accessible to the user computing device 110 suitable for storing information. In an example, the data storage unit 115 stores encrypted information, such as HTML5 local storage.

An example payment processing system 140 is configured to conduct transactions for a user payment account. The payment processing system 140 receives requests to conduct transactions from the user, the camera module 114, or a merchant system, and provides an authorization for the transaction. The payment processing system 140 may receive an authorization for the transaction from a card issuer or other financial institution, or the payment processing system 140 may provide the authorization itself. The payment processing system 140 may be associated with the payment application 113 or another payment instrument of the user 101 or the merchant system.

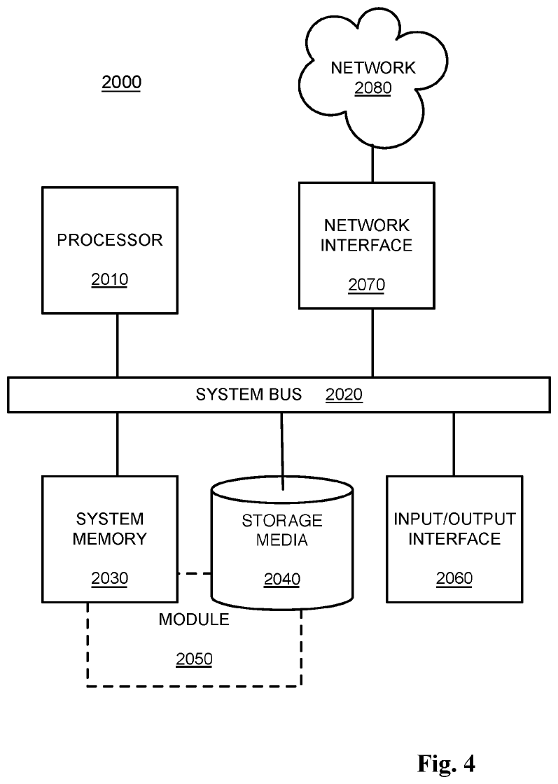

In examples, the network computing devices and any other computing machines associated with the technology presented herein may be any type of computing machine such as, but not limited to, those discussed in more detail with respect to FIG. 4. Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 4. The computing machines discussed herein may communicate with one another, as well as with other computing machines or communication systems over one or more networks, such as network 120. The network 120 may include any type of data or communications network, including any of the network technology discussed with respect to FIG. 4.

### Example Processes

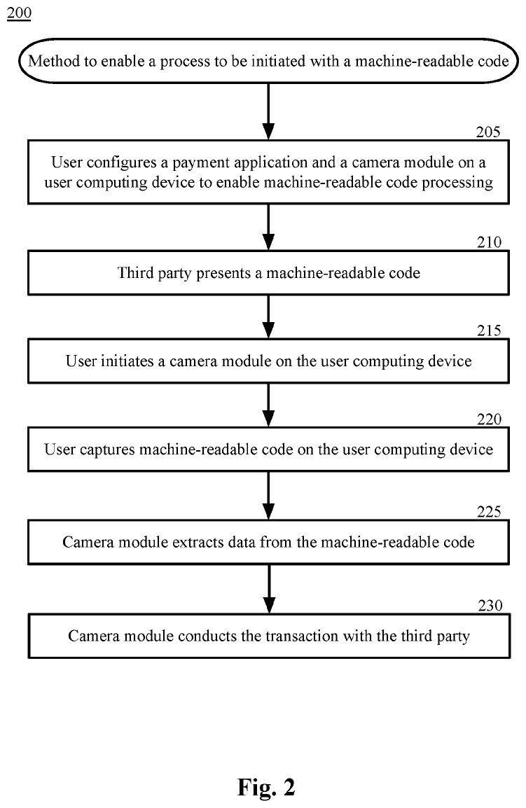

The example methods illustrated in FIG. 2 is described hereinafter with reference to the components of the example operating environment 100. The example methods of FIG. 2 may also be performed with other systems and in other environments.

FIG. 2 is a block flow diagram depicting a method to enable a process to be initiated with a machine-readable code, in accordance with certain examples.

In block 205, a user 101 configures a payment application 113 and a camera module 114 on a user computing device 110 to enable machine-readable code processing. In an example, the user 101 downloads the payment application 113 onto a user computing device 110 from a website of a payment processing system 140 or other suitable location. In an example, the camera module 114 is installed on the user computing device 110 as purchased as is not installed at a later time. In an alternate example, the camera module 114 is installed on the user computing device 110 after downloading the camera module 114 from the payment processing system 140 or a third party location.

In an example, the camera module 114 and the payment application 113 are part of the same application. For example, the camera module 114 operates as a function of the payment application 113 and is initiated from the payment application 113. In another example, the camera module 114 and the payment application 113 are associated such that when either of the camera module 114 and the payment application 113 are opened, the other application automatically opens.

In block 210, a third party presents a machine-readable code. In an example, the third party is a merchant location or other transaction party, such as a peer in a peer-to-peer transaction. The machine-readable code may be created at the time of a transaction. For example, the details of the transaction may be incorporated in the machine-readable code, such as the transaction monetary amount, identification of the merchant, the time and date, an account identification to receive funds, or any other suitable information. In an alternate example, the machine-readable code is created at a prior time and is presented at the time of the interaction. The machine-readable code may be presented on a display of an electronic device, presented on a printed sheet, or presented in any other suitable manner. The machine-readable code may be a QR code, a barcode, or any other suitable machine-readable code.

In block 215, the user 101 initiates a camera module 114 on the user computing device 110. In the continuing example, the method 200 is described as being performed primarily via the camera module 114. However, in alternate examples, the payment application 113 may incorporate a camera and perform the method 200. In other examples, some functions may be performed by one of the camera module 114 or the payment application 113 while other functions are performed by the other. In other examples, other applications or modules may perform certain functions of the method 200. In the example, the user 101 initiates the camera module 114 by actuating an interface object for the camera module 114.

In block 220, the user 101 captures the machine-readable code on the user computing device 110 via the camera module 114. The user 101 simply opens a camera module 114 on the user computing device 110 and directs the camera module 114 at a presented machine-readable code to initiate a process, such as a purchase transaction. The machine-readable code is automatically read and a payment flow is initiated. In the example, a separate application for scanning machine-readable code is not required because the camera module is configured to interpret the machine-readable code data. The machine-readable code may be scanned from an electronic display, a printed sheet, or any other suitable machine-readable code presentation.

In block 225, the camera module 114 extracts data from the machine-readable code. The scanning of the machine-readable code and the interpretation of payment machine-readable code to initiate the appropriate payment method may be written into the camera application programming interface (“API”). The data required for the transaction to be conducted, such as a transaction amount, may be encoded into the machine-readable code. That is, when the machine-readable code is scanned, all required payee data for conducting the transaction is encoded in the machine-readable code, and thus received by the user computing device 110. In the example, this scanning is conducted directly by the camera module 114, and a separate machine-readable code scanning application is not required. For example, the transaction amount, the merchant identification, information about the product or service purchased, or any other useful data are all included in the data encoded in the machine-readable code. When the machine-readable code is scanned, required data is received and interpreted by the user computing device 110. This example is especially useful for cases where the transaction amount and merchant system are standardized, such as highway tolls.

In alternate examples, the camera module 114 recognizes that the machine-readable code requests a payment and initiates the payment application 113 or another payment source. The camera module 114 may communicate the payment request to the payment application 113 to perform the payment.

In block 230, the camera module 114 conducts the transaction with the third party. In the example, the camera module 114 includes payment information associated with the payment processing system 140. The camera module 114 directs the data from the machine-readable code along with user payment information, such as a user account ID, to the payment processing system 140. The payment processing system 140 receives the data and transfers the requested amount to the third party account. As described herein, the camera module 114 may alternatively initiate the payment application 113 to conduct the transaction via the payment processing system 140. For example, the camera module 114 communicates the data for the transaction to the payment application 113 to allow the payment application to conduct the transaction.

In an example, the method 200 allows a user 101 to conduct the transaction in certain situations without the requirement of a confirmation or verification step. That is, after the machine-readable code is scanned, the transaction is conducted automatically without the user 101 verifying the transaction. The act of scanning the machine-readable code is the only action required of the user 101.

In an example, the method 200 will optionally authorize the user 101 to conduct automatic transactions based on risk signals. For example, if the transaction is for a small amount at a frequent merchant, the risk can be determined to be low enough that verification is not required. For example, if a user 101 pays a fee to ride a subway everyday, a subsequent machine-readable code transaction at the subway will be determined to be a low risk and does not require verification from the user 101. In another example, the method 200 is configured to allow any transaction under a certain amount to be conducted without verification from the user 101.

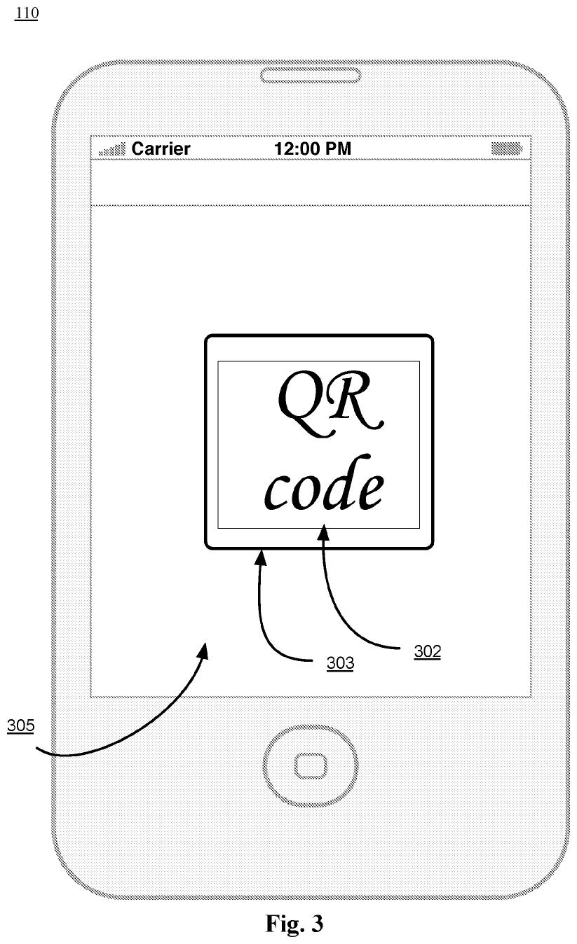

FIG. 3 is an illustration of an example user computing device scanning a machine-readable code, in accordance with certain examples.

In the example, the user computing device 110 is shown displaying a user interface 305 of the camera module 114. The user interface 305 is displaying an image of a QR code 302 at which the camera module 114 is directed. The QR code 302 is positioned in a box 303 to allow the QR code 302 to be scanned. Once scanned the data from the QR code 302 is interpreted by the camera module 114 to initiate a transaction.

### Other Examples

FIG. 4 depicts a computing machine 2000 and a module 2050 in accordance with certain examples. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain examples, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different examples, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A system to initiate transactions with machine-readable codes, comprising:
a storage device;
a camera module; and
a processor communicatively coupled to the storage device and the camera module, wherein the processor executes application code instructions that are stored in the storage device to cause the system to:
receive an input to initiate the camera module at a time of an interaction with a third party;
receive a digital image from the camera module, the digital image comprising a machine-readable code;
extract data from the machine-readable code, the data comprising an identification of the third party and a third party account; and
automatically communicate to a processing system, the extracted data, data associated with a user associated with the storage device and the camera module, and a request to communicate a record to the third party.

2. The system of claim 1, wherein the wherein the processor executes application code instructions that are stored in the storage device to cause the system to:
determine a risk signal for the transaction; and
determine to communicate the record to the third party based on the risk signal.

3. The system of claim 1, wherein the storage device and the camera module are components of a user computing device.

4. The system of claim 1, wherein the machine-readable code is created by the third party after the interaction is initiated.

5. The system of claim 1, wherein automatically communicating to the processing system the data associated with the user associated with the storage device and the camera module, and the request to communicate the record to the third party includes automatically communicating to the processing system without a user input being received after the input to initiate the camera module is received.

6. The system of claim 1, wherein the machine-readable code is a QR code.

7. The system of claim 1, wherein the machine-readable code is displayed on an electronic display.

8. The system of claim 1, wherein the machine-readable code is displayed on a printed sheet.

9. The system of claim 1, wherein the machine-readable code is created by the third party at a time before the interaction.

10. The system of claim 1, wherein the storage device and the camera module are components of a user computing device and wherein the system further comprises one or more computing devices of a merchant system associated with the third party, the one or more computing devices of the merchant system being configured to:
configure a payment account to receive payments from users;
receive a request to conduct a transaction;
create a machine-readable code comprising data associated with an account of the merchant system;
present the machine-readable code to a particular user associated with the user computing device; and
receive a notice that the user has provided a transfer of funds to the account.

11. A computer-implemented method to initiate transactions with machine-readable codes, comprising:
configuring, by one or more computing devices of a merchant system, a payment account to receive payments;
receiving, by the one or more computing devices, a request to conduct a transaction;
creating, by the one or more computing devices, a machine-readable code comprising data associated with an account of the merchant system;
presenting, by the one or more computing devices, the machine-readable code to a user;
automatically communicating, by a user computing device of the user to a processing system, data associated with the user; and
receiving, by the one or more computing devices from the processing system, a notice that the user has provided a transfer of funds to the account.

12. The computer-implemented method of claim 11, wherein the machine-readable code is created after the interaction is initiated.

13. The computer-implemented method of claim 11, wherein the machine-readable code is created by the third party at a time before the interaction.

14. The computer-implemented method of claim 11, wherein the machine-readable code is displayed on at least one of a printed sheet or an electronic display.

15. (canceled)

16. The computer-implemented method of claim 11, wherein the machine-readable code is a QR code.

17. A computer-implemented method to initiate transactions, comprising:
receiving, by one or more computing devices, receive an input to initiate a camera module at a time of an interaction with a third party;
receiving, by the one or more computing devices, the digital image comprising a machine-readable code;
extracting, by one or more computing devices, data from the machine-readable code, the data comprising an identification of the third party and a third party account; and
automatically communicating, by one or more computing devices, the extracted data, data associated with a user associated with the storage device and the camera module, and a request to communicate a record to the third party.

18. The computer-implemented method of claim 17, wherein the machine-readable code further comprises an amount of funds to be transferred to the third party.

19. The computer-implemented method of claim 17, wherein the camera module is a component of a user computing device.

20. The computer-implemented method of claim 17, wherein the machine-readable code is a QR code.

21. (canceled)

22. (canceled)

23. (canceled)

24. The system of claim 2, wherein the risk signal for the transaction is determined based on at least one of a payment amount or a frequency associated with the transaction.
